(19) United States
(12) Patent Application Publication
(10) Pub. No.: US 2026/0090530 A1
(43) Pub. Date: Apr. 2, 2026

(54) SYSTEMS, METHODS, AND ASSEMBLIES FOR PROVIDING A PADDLE WITH A STOWED READY-TO-USE SPEAR

(71) Applicant: JAIME BUICE, SUGAR HILL, GA (US)

(72) Inventor: JAIME BUICE, SUGAR HILL, GA (US)

(21) Appl. No.: 19/346,633

(22) Filed: Oct. 1, 2025

Related U.S. Application Data
(60) Provisional application No. 63/701,833, filed on Oct. 1, 2024.

(51) Int. Cl. A01K 81/04; B63H 16/04

(52) U.S. Cl. CPC A01K 81/04; B63H 16/04

(57) ABSTRACT

Various embodiments are disclosed for providing a paddle with a stowed ready-to-use spear. One embodiment is a spear assembly comprising a spear element and an elastically compressible plug coupled to the spear element. The elastically compressible plug is configured for insertion into a hollow paddle shaft, and further configured to deform radially outward upon axial compression to secure the spear assembly within the hollow paddle shaft.

### CROSS-REFERENCE TO RELATED APPLICATION

This application claims the benefit of the priority of U.S. Provisional Patent Application Ser. No. 63/701,833 entitled “Paddle Assembly with Stowed Ready-to-Use Spear” and filed on Oct. 1, 2024, which is hereby incorporated by reference in its entirety.

### DESCRIPTION OF THE RELATED ART

Paddle sports continue to grow in popularity as a recreational water sport. There are now numerous different types, styles, and designs of paddles to propel the paddle craft (e.g., standup paddle board (SUP), canoe, kayak, etc.) and to accommodate different performance, ergonomic, and user preferences. Regardless of the type of paddle craft and paddle design, there is always the inherent risk that a dangerous or life-threatening animal may be encountered in the natural conditions and/or geographic location of the body of water (e.g., ocean, lake, river, etc.). In such situations, the paddle may be used as an improvised weapon or defensive tool to fend off the animal. However, and despite the widespread success and commercial availability of the various paddle designs, there remains a need for improved paddle designs that provide quick, effective protection in potentially dangerous situations.

### SUMMARY

Various embodiments are disclosed for providing a paddle with a stowed ready-to-use spear. One embodiment is a spear assembly comprising a spear element and an elastically compressible plug coupled to the spear element. The elastically compressible plug is configured for insertion into a hollow paddle shaft, and further configured to deform radially outward upon axial compression to secure the spear assembly within the hollow paddle shaft.

Another embodiment is a method for providing a paddle with a stowed ready-to-use spear. The method comprises: providing a spear assembly comprising a spear element and a compressible plug; disengaging a pair of hollow shafts comprising a paddle; inserting the compressible plug into a proximal end of one of the pair of hollow shafts with the spear element at least partially extending from the proximal end; axially compressing the compressible plug to cause radial deformation and secure fixation of the spear assembly within the one of the pair of hollow shafts; and stowing the spear element inside the other of the pair of hollow shafts for normal operation of the paddle by reengaging the pair of hollow shafts.

Yet another embodiment is a paddle assembly for providing a stowed ready-to-use spear. The paddle assembly comprises a paddle and a spear assembly. The paddle comprises a pair of hollow shafts configured for telescopic engagement. The spear assembly comprises a spear element and an elastically compressible plug coupled to the spear element. The elastically compressible plug is configured for insertion into one of the pair of hollow shafts, and further configured to deform radially outward upon axial compression to secure the spear assembly within the one of the hollow shafts.

### BRIEF DESCRIPTION OF THE DRAWINGS

FIG. 1 is a perspective view of an embodiment of a standup paddle board (SUP) paddle assembly with a stowed ready-to-use spear.

FIG. 2 illustrates the SUP paddle assembly of FIG. 1 in which the paddle shafts have been telescopically disengaged to reveal an embodiment of a stowable ready-to-use spear.

FIG. 3a is a perspective view of an embodiment of a retrofit spear kit for retrofitting a paddle with a stowed ready-to-use spear.

FIG. 3b shows an unassembled component view of an embodiment of the spear assembly in FIG. 3a.

FIG. 4 is a partial cutaway view of the hollow paddle shaft illustrating the compressible plug in an uncompressed state.

FIG. 5 shows the compressible plug of FIG. 4 in an axially compressed and radially expanded state.

FIG. 6 is a schematic view illustrating an exemplary method for providing a paddle with a stowable ready-to-use spear.

### DETAILED DESCRIPTION

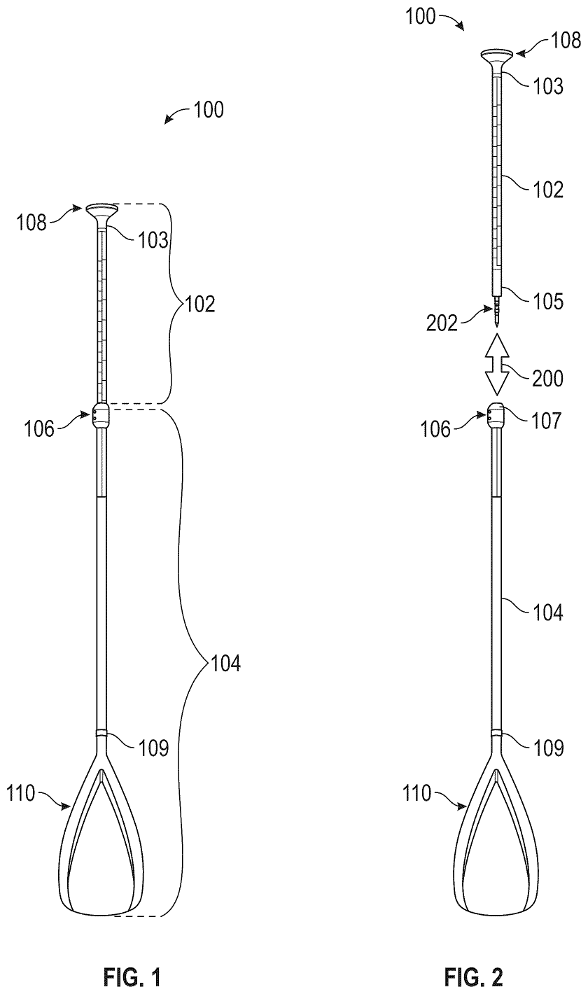

As described below in more detail with reference to FIGS. 1-6, various embodiments of systems, methods, and assemblies are disclosed for providing a paddle with a stowed ready-to-use spear. The ready-to-use spear design safely conceals the spear during normal operation (e.g., in storage, during transportation prior to use, and when the paddle is being used to propel a paddle craft) yet enables quick, ready-to-use access when needed for protection or other defensive purposes in potentially dangerous situations. One of ordinary skill in the art will appreciate that the ready-to-use spear design may be implemented in various types, styles, and designs of paddles used in connection with any desirable paddle craft (e.g., standup paddle board (SUP), canoe, kayak, etc.) and to accommodate different performance, ergonomic, cost, aesthetic, or other user or use case preferences. In this regard, it should be appreciated that one or more of the paddle components described below (e.g., shaft, blade, handle, spear, adjustable length lock assembly/member(s), connection member(s), or other structural or mechanical components, etc.) may be implemented with any desirable materials or combinations of materials, including, for example, plastic, aluminum, carbon fiber, or wood.

FIGS. 1 and 2 illustrate one embodiment of a standup paddle board (SUP) paddle assembly 100 for implementing a stowed ready-to-use spear design. SUP paddle assembly 100 comprises a pair of removably and telescopically engaging paddle shafts including a handle shaft 102 and a paddle shaft 104. Handle shaft 102 comprises a first proximal end 103 and a first distal end 105. A suitably-configured handle 108 may be disposed at the first proximal end 103. Paddle shaft 104 comprises a second proximal end 107 and a second distal end 109. A paddle blade 110 is disposed on the second distal end 109.

At least an upper portion of paddle shaft 104 beginning at second proximal end 107 is hollow and configured to receive the first distal end 105 of handle shaft 102. In this manner, paddle shaft 104 and handle shaft 102 telescopically engage with respect to each other to enable the user to adjust the overall paddle length. A lock mechanism 106 may be disposed on the second proximal end 107 of paddle shaft 104. Lock mechanism 106 is selectively configurable between an unlocked state and a locked state. The unlocked state enables handle shaft 102 to removably and telescopically engage with paddle shaft 104. The locked state fixes handle shaft 102 and paddle shaft 104 at an adjustable desired paddle length. Any suitable lock mechanism may be implemented, including conventional clamp-style length adjustment assemblies.

As illustrated in FIG. 2, paddle assembly 100 further comprises a spear tip 202 disposed on the first distal end 105 of handle shaft 102. This configuration provides a ready-to-use spear design that safely conceals spear tip 202 during normal operation (FIG. 1) yet advantageously enables quick, ready-to-use access (FIG. 2) when needed for protection or other defensive purposes.

The spear may be disposed on either the first distal end 105 of handle shaft 102 or the second proximal end 107 of paddle shaft 104. The spear may be fixed to either shaft in a fixed manner, a removably fixed manner, or integrally formed at the shaft end. The spear may comprise various configurations including harpoon-style tips, telescoping spear assemblies that may be retracted and elongated, removable spear assemblies with caps configured to be received within hollow shaft ends, and removable handle configurations where the spear is disposed on the proximal end and partially received within a removable handle member. Further embodiments may include telescoping spear assemblies, integral spear formations with various tip geometries, removable handle configurations, and adaptation to various paddle types including kayak-style paddles with paddle blades disposed on both ends.

One of ordinary skill in the art will appreciate that the ready-to-use spear design may be implemented in various types, styles, and designs of paddles used in connection with any desirable paddle craft such as standup paddle boards (SUP), canoes, kayaks, and others, and to accommodate different performance, ergonomic, cost, aesthetic, or other user preferences. One or more of the paddle components may be implemented with any desirable materials or combinations of materials, including plastic, aluminum, carbon fiber, wood, stainless steel, hardened alloys, titanium, or composite structures.

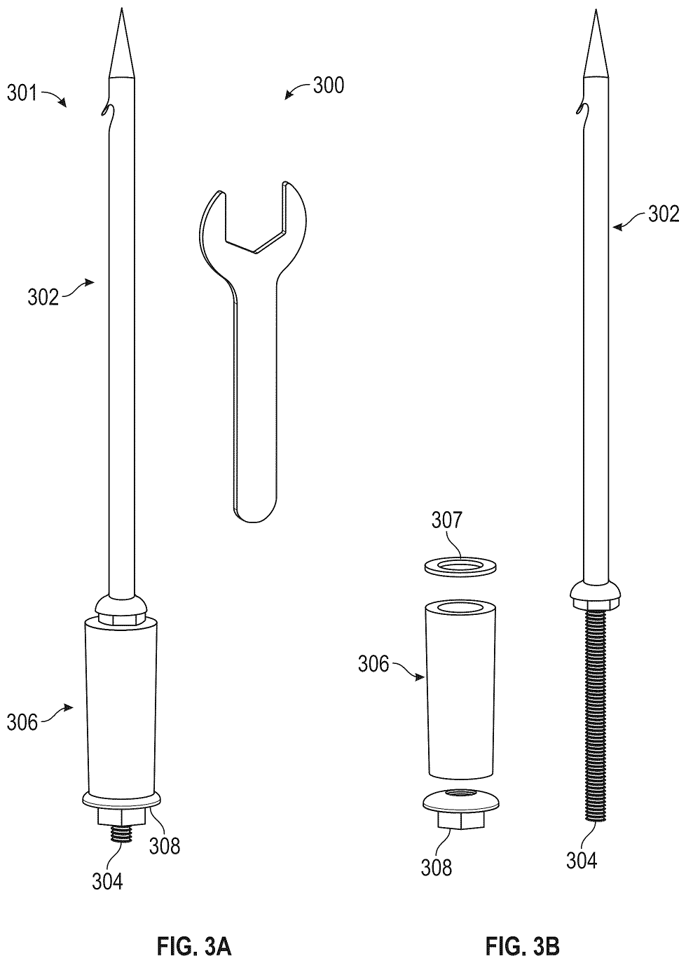

As illustrated in FIG. 3a, a retrofit spear kit 300 may be provided for after-market installation of the ready-to-use spear design in an existing paddle, such as the SUP paddle illustrated in FIGS. 1 & 2. The retrofit spear kit 300 allows the spear assembly 301 to be easily installed and safely stowed inside the paddle shaft during normal paddle operation, and to be readily accessed and deployed when needed for defensive or survival purposes. It should be appreciated that retrofit embodiments and the spear assembly 301 may provide advantageous after-market adaptation of commercially available paddles without permanent alteration of the paddle shaft structure. However, one of ordinary skill in the art will appreciate that spear assembly 301 (and other embodiments of the ready-to-use spear design) may be employed in any suitable paddle assembly, paddle design or configuration, or otherwise integrated with the telescopically engaging paddle shafts comprising the paddle.

As shown in FIGS. 3a and 3b, an embodiment of a retrofit spear kit 300 may comprise a spear assembly 301 and an installation tool (e.g., a wrench 303). Spear assembly 301 comprises a spear element 302, a threaded fastener 304 coupled to the spear element 302, a compressible plug 306 disposed about the fastener 302, and a flange nut 308 that threadably engages with the fastener 302 to axially compress the plug 306 during installation. As described below in more detail, axial compression of the plug 306 causes radial expansion into engagement with the paddle shaft wall, thereby locking the spear assembly 301 in place within the shaft.

In one embodiment, spear element 302 comprises a stainless-steel spear approximately six inches in length, having a sharpened distal end suitable for defensive use. Stainless steel may be useful due to its strength, durability, and corrosion resistance in both freshwater and saltwater environments. Other materials may also be employed, including hardened alloys, aluminum, titanium, or composite spear structures.

The threaded fastener 304 (e.g., M8×1.25 hex bolt approximately three inches in length) may be rigidly affixed to a proximal base of the spear element 302. In one embodiment, the head of the bolt may be welded directly (or otherwise fixed) to a base surface of the spear element 302, forming a metallurgical joint capable of withstanding repeated loading during insertion, tightening, and removal. As known in the art, welding techniques may include TIG, MIG, spot welding, or brazing. In alternative embodiments, the fastener 304 may be attached by threaded engagement, mechanical fastening, or adhesive bonding.

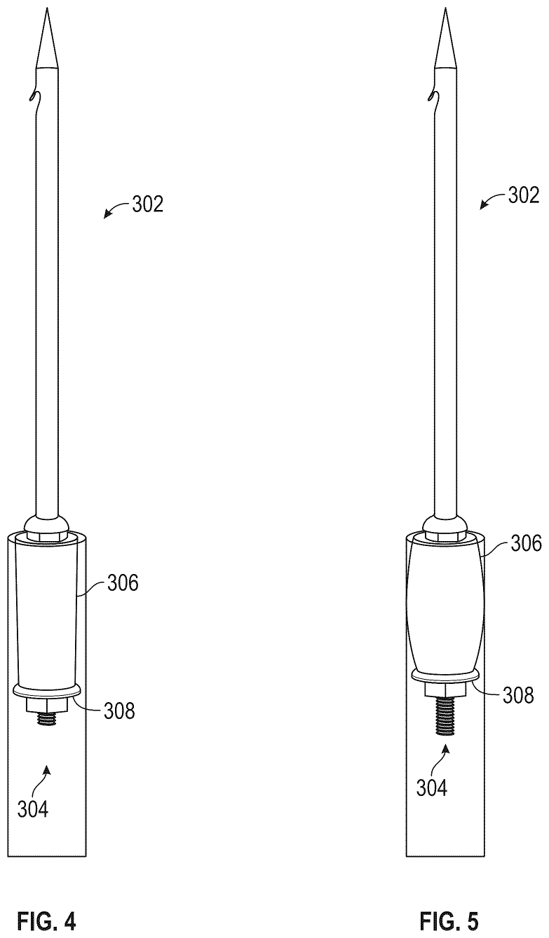

As illustrated in FIGS. 4 and 5, the compressible plug 306 may be disposed concentrically about the threaded shank of the fastener 304. In one embodiment, plug 306 comprises a cylindrical silicone rubber member having a length of approximately 1¾ inches, an outer diameter of approximately ⅛ inch, and a central bore configured to receive the fastener shank. The plug 306 may be fabricated from silicone rubber having a durometer hardness ranging from approximately 40 A to 70 A, with approximately 55 A being used in certain embodiments for optimal balance of compressibility and retention force. Softer materials (40 A-50 A) may be implemented where desirable to provide easier compression and installation but may require higher axial forces for adequate retention, while harder materials (60 A-70 A) may provide stronger retention force but may require greater installation torque. One of ordinary skill in the art will appreciate that the elastically compressible properties are suitable for repeated installation and removal cycles without permanent deformation.

The material selection and dimensions may be selected for compatibility with hollow paddle shafts, which are typically formed of thin-walled carbon fiber, aluminum, wood, or composite materials having inner diameters ranging from about ⅜ inch to about 1 inch. Unlike construction or industrial applications, paddle shafts may require non-damaging retention mechanisms that distribute loads uniformly to prevent stress concentration and potential cracking of lightweight materials. In this regard, it should be appreciated that the elastically compressible plug 306 provides controlled radial expansion that conforms to slight variations in shaft inner diameter while maintaining reversible installation without permanent alteration of the paddle structure.

Alternative elastomeric or polymeric materials may be used, including polyurethane, EPDM, neoprene, thermoplastic elastomers, or compressible foams, provided they offer suitable elastic recovery properties for marine environments including saltwater corrosion resistance and temperature cycling. The plug may be cylindrical, tapered, segmented, or otherwise shaped to facilitate uniform expansion when compressed while maintaining precision-fit tolerances for recreational equipment applications.

The flange nut 308 is threadably engaged with the distal end of the fastener shank. The flange nut 308 includes an annular flange that provides a bearing surface against the distal face of the plug 306. In one embodiment, the flange nut 308 comprises a stainless steel M8×1.25 serrated flange nut. The serrations enhance vibration resistance and resist loosening under dynamic loads. A washer 307 may optionally be disposed between the flange nut 308 and the plug 306 to distribute axial load and minimize shear stresses on the plug 306.

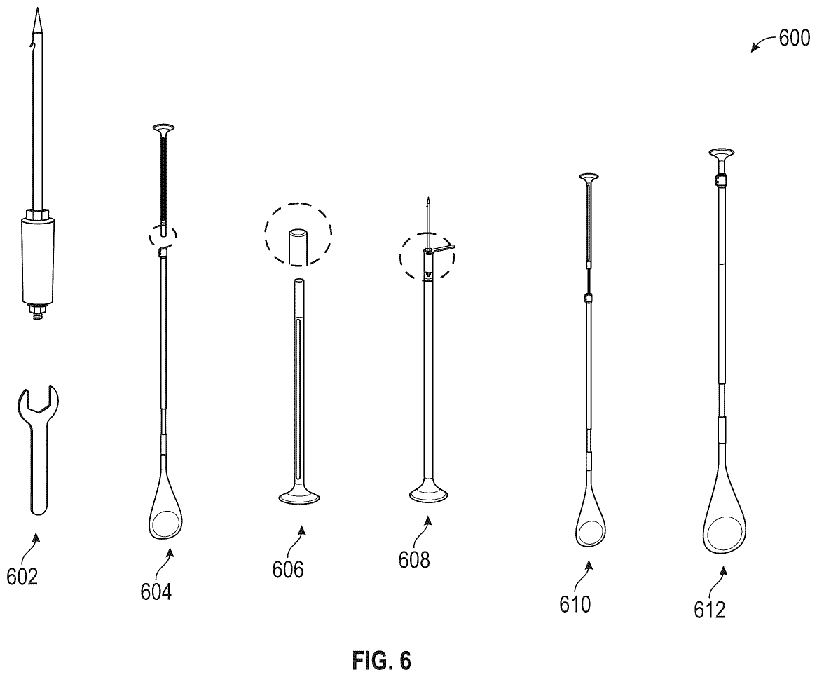

FIG. 6 is a schematic view illustrating an exemplary installation method 600 for providing a paddle with a stowable ready-to-use spear. At step 602, a retrofit spear kit 300 may be provided with a spear assembly 301 and a wrench 303. In one embodiment, the retrofit spear kit 300 is provided in a bundled arrangement or as an add-on with the purchase of a paddle and/or SUP board. In other embodiments, the retro spear kit 300 may be purchased or otherwise provided separately. The installation method 600 continues at step 604—disengaging the pair of hollow shafts comprising the paddle by the handle shaft from the paddle shaft. At step 606, an end cap (if applicable) may be removed from the hollow paddle shaft to expose the shaft interior.

As further illustrated in FIGS. 4 and 6, at step 608 the spear assembly 301 (comprising spear element 302 and attached fastener 304 with compressible plug 306) is inserted into the proximal end of the hollow paddle shaft until the spear base abuts the shaft end and the compressible plug 306 is positioned fully within the shaft interior, with the spear element 302 at least partially extending from the proximal end. With the assembly positioned, axial compression is applied to the compressible plug 306 using the provided hex wrench 303, such as by engaging the hexagonal head of the fastener 304. It should be appreciated that rotating the fastener 304 causes the flange nut 308 to translate axially along the threaded shank toward the bolt head, thereby axially compressing the compressible plug 306 between the flange nut 308 and the bolt head. This axial compression causes the plug 306 to deform radially outward, creating secure fixation of the spear assembly 301 within the hollow paddle shaft.

As best illustrated in FIG. 5, axial compression of the plug 306 induces radial deformation of the plug 306 against the interior wall of the paddle shaft. This radial expansion generates circumferential contact pressure and produces frictional engagement between the plug 306 and the shaft wall, thereby locking the spear assembly 301 in place. Once secured, at step 610, the paddle shafts are reengaged by reinserting the handle shaft into the paddle shaft, creating the final sheathed configuration shown at step 612 where the spear element 302 is stowed inside the handle shaft for normal operation of the paddle. During normal use, the spear assembly 301 remains hidden and does not affect paddle function. When deployment is required, the handle shaft may be removed from the paddle shaft, immediately exposing the ready-to-use spear for defensive purposes. For complete removal or maintenance, the fastener may be loosened to relieve plug compression, allowing the spear assembly 301 to be uninstalled from the shaft.

Variations of the retrofit spear kit 300, the spear assembly 301, and installation method 600 are contemplated. For example, one of ordinary skill in the art will appreciate that alternative implementations may employ multiple plugs disposed along the fastener shank to provide increased retention or redundancy. Plugs may be shaped to include stepped or tapered profiles for progressive expansion. Alternative expansion mechanisms may include split collets, wedge-driven segments, or inflatable bladders. The flange nut 308 may be replaced with a tool-less tightening member such as, for example, a knurled knob, a cam lever, or an integrated compression sleeve.

It should be further appreciated that spear element 302 may be provided in different lengths or geometries, including barbed, harpoon-style, or blunt-tipped variations. The retrofit spear kit 300 may be provided as a standalone after-market kit including the pre-assembled spear assembly 301 (comprising the spear element 302, fastener 304, plug 306, and flange nut 308) and an installation tool such as a hex wrench 303. Alternatively, the spear assembly 301 may be supplied pre-installed with a paddle.

The disclosed systems, methods, and assemblies for providing a paddle with a stowed ready-to-use spear may provide a low-cost, robust, and reversible solution for enhancing safety in paddle sports. By leveraging axial compression and radial expansion of a plug within a hollow shaft, the assembly allows secure vibration-resistant mounting of a spear element inside existing paddle shafts, without requiring adhesives, pins, or permanent alterations to the paddle.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention.

What is claimed is:

1. A spear assembly for providing a paddle with a stowed ready-to-use spear, the spear assembly comprising:
a spear element; and
an elastically compressible plug coupled to the spear element and configured for insertion into a hollow paddle shaft, the elastically compressible plug configured to deform radially outward upon axial compression to secure the spear assembly within the hollow paddle shaft.

2. The spear assembly of claim 1, further comprising:
a threaded fastener coupled to the spear element, wherein the elastically compressible plug is disposed concentrically about the threaded fastener, and the axial compression is provided by threaded engagement.

3. The spear assembly of claim 2, wherein the threaded fastener comprises a hex bolt rigidly fixed to the spear element and a flange nut configured to compress the elastically compressible plug in response to rotation of the threaded fastener.
The spear assembly of claim 1, wherein the elastically compressible plug comprises a silicone rubber material having a durometer hardness between approximately 40 A and 70 A.

5. The spear assembly of claim 1, wherein the elastically compressible plug has an uncompressed outer diameter configured for insertion into paddle shafts having inner diameters ranging from approximately ⅜ of an inch to 1 inch.

6. The spear assembly of claim 1, wherein the spear element and the elastically compressible plug comprise a retrofit spear kit.

7. A paddle assembly comprising:
a paddle comprising a pair of hollow shafts configured for telescopic engagement; and
a spear assembly for providing the paddle with a stowed ready-to-use spear, the spear assembly comprising:
a spear element; and
an elastically compressible plug coupled to the spear element and configured for insertion into one of the pair of hollow shafts, the elastically compressible plug configured to deform radially outward upon axial compression to secure the spear assembly within the one of the hollow shafts.

8. The paddle assembly of claim 7, wherein the spear assembly further comprises:
a threaded fastener coupled to the spear element, wherein the elastically compressible plug is disposed concentrically about the threaded fastener, and the axial compression is provided by threaded engagement.

9. The paddle assembly of claim 8, wherein the threaded fastener comprises a hex bolt rigidly fixed to the spear element and a flange nut configured to compress the elastically compressible plug in response to rotation of the threaded fastener.

10. The paddle assembly of claim 7, wherein the elastically compressible plug comprises a silicone rubber material having a durometer hardness between approximately 40 A and 70 A.

11. The paddle assembly of claim 7, wherein the spear assembly comprises a retrofit spear kit.

12. The paddle assembly of claim 7, wherein one of the pair of hollow shafts comprises a paddle shaft and the other of the pair of hollow shafts comprises a handle shaft.

13. The paddle assembly of claim 7, wherein the spear element comprises a stain-steel spear.

14. The paddle assembly of claim 7, wherein the paddle comprises one of a standup paddle board (SUP) paddle and a kayak paddle.

15. A method for providing a paddle with a stowed ready-to-use spear, the method comprising:
providing a spear assembly comprising a spear element and a compressible plug;
disengaging a pair of hollow shafts comprising a paddle;
inserting the compressible plug into a proximal end of one of the pair of hollow shafts with the spear element at least partially extending from the proximal end;
axially compressing the compressible plug to cause radial deformation and secure fixation of the spear assembly within the one of the pair of hollow shafts; and
stowing the spear element inside the other of the pair of hollow shafts for normal operation of the paddle by reengaging the pair of hollow shafts.

16. The method of claim 15, wherein the providing the spear assembly comprises providing a retrofit spear kit comprising the spear assembly and a tool for axially compressing the compressible plug.

17. The method of claim 16, wherein the spear assembly further comprises a threaded fastener coupled to the spear element, and the compressible plug is disposed concentrically about the threaded fastener.

18. The method of claim 17, wherein the tool provided with the retrofit spear kit comprises a wrench, and the axial compression is provided by threaded engagement using the wrench.

19. The paddle assembly of claim 17, wherein the threaded fastener comprises a hex bolt rigidly fixed to the spear element and a flange nut configured to elastically compress the compressible plug in response to rotation of the threaded fastener.

20. The paddle assembly of claim 1, wherein the paddle comprises one of a standup paddle board (SUP) paddle and a kayak paddle.
